(19) United States
(12) Patent Application Publication
(10) Pub. No.: US 2006/0150960 A1
(43) Pub. Date: Jul. 13, 2006

(54) Spark plug with voltage amplifier and conical/hemi-spherical spark chamber

(76) Inventor: Derek Edward Boudreau, Woodbridge, VA (US)

Correspondence Address: DEREK BOUDREAU, 11580 OVERLEIGH DR., WOODBRIDGE, VA, 22192, US

(21) Appl. No.: 11/115,612

(22) Filed: Jan. 13, 2005

(51) Int. Cl. F02P 15/00; F23Q 3/00

(52) U.S. Cl. 123/620; 361/253

(57) ABSTRACT

A spark plug with a voltage amplifier includes an upper spark plug body similar to a convention spark plug except that it contains a voltage amplifier or similar device to increase the voltage output or change the characteristics of the spark being emitted. The lower section of the invention is similar to a conventional plug except that the bottom has a concave surface adjacent and above the hot and ground electrodes. The two electrodes are placed far apart on each side of the concave bottom thus allowing for the larger spark and focused reflection of ignition into the piston chamber.

### FIELD OF THE INVENTION

This invention is directed to the field of spark plugs or other ignition devices for internal combustion engines or the like for igniting fuel within the engine.

### BACKGROUND OF THE INVENTION

Spark plugs generally are made of a conductor core surrounded by porcelain or other insulating material. The insulating material follows the conductor core of the plug to the bottom where the conducting core is exposed allowing the current to produce a spark across the air gap to the ground electrode. This electrode is connected to the metal body of the plug, which is in contact with the engine block completing the electrical circuit.

Traditionally, spark plugs have been gapped small to allow the spark to effectively jump from the hot electrode to the ground electrode. This small gap, however, reduces the spark contact surface to the fuel/air mixture. It is a known problem that the combustion of the fuel/air mixture is not 100% complete, allowing raw fuel vapor to exit out the exhaust of the engine. When significant amounts of fuel vapor is not being burned inside the cylinders and is continuing though the exhaust system, “backfiring” can develop which is small explosions from this un-burnt fuel/air mixture igniting somewhere in the exhaust system creating the “backfire” or loud “bang”. If not all of the fuel/air mixture is being burned inside the cylinders at the appropriate time (when the piston is beginning its down stroke) the engine's fuel efficiency is reduced.

Bosch plugs offer a horizontal spark from the hot electrode to one of four possible ground electrodes. Other companies, including Bosch, offer conducting cores with less electrical resistance than other designs by using a core, tip or part of with a highly conductive material such as platinum, gold or copper. These designs which can increase the performance of the plug by less resistance do not offer any device to actually increase voltage and spark size.

Several companies on the market offer current peaking capacitors and other devices, which are installed inside the engine compartment as add-on components to the engine's ignition system. These devices are known to increase voltage output and the spark characteristics (e.g. spark duration, frequency), delivering more power and more complete combustion of fuel. However, installation is a more involved procedure than installing new spark plugs. It requires additional time and knowledge to install the electrical components into engine's ignition system. Usually race enthusiasts or those backyard mechanics that want a performance option on their sports car buy these components. Spark plug wires also exist which contain capacitors inside the wires to deliver higher voltage. A patent (U.S. Pat. No. 4,412,151) for a spark plug has been given for a design, which includes piezoelectric crystals. However, it is believed that no known design exists which includes a voltage amplifier inside the spark plug. This invention is designed to operate with the existing ignition system of an internal combustion engine but replacing the convention spark plugs. Simplicity of design aids the usefulness of the invention to consumers. No longer are they required to make major modifications to their ignition systems to obtain increased performance from an apparatus that boosts voltage. They can now, in theory, reap the benefits of increased horse power and fuel economy just by the installation of the said invention. The said invention could possibly reach and help the large majority of the automotive and light truck market, your everyday drivers, with the dream of lower gas consumption nationwide one vehicle at a time.

### SUMMARY OF INVENTION

This invention is a spark plug 1 contains a voltage amplifier or similar device to boost voltage within the spark plug. The plug produces a more powerful spark and therefore can have a wider gap 3. The bigger spark energy translates into greater fuel efficiency and increased horsepower. The bottom of the spark plug could be designed to take advantage of the larger voltage spark. The bottom electrode 4 with insulating post could be positioned off to the side, instead of the center of the bottom of the plug. The anode 5 could then be positioned in a similar fashion on the adjacent side, sticking out the bottom of the plug. The insulating material 6 on the bottom of the plug could then be shaped in a concave manner to concentrate and help direct the resulting explosion from the spark in the first micro-seconds. This helps to project the resulting flame kernel further into the combustion chamber aiding in the more complete combustion of fuel. A more powerful explosion resulting from the more complete combustion of fuel provides more power against the piston head.

A microprocessor or other device could be added to the spark plug to vary the characteristics of the spark. For example, voltage spike form (e.g. duration, consistency) or number of sparks or to help regulate timing of the engine.

Another embodiment of this invention is a spark plug adapter which fits over a spark plug that includes the voltage amplification device of the main embodiment. This adapter could be placed on the users existing plugs connecting the existing spark plug wires to the spark plugs without further modifications to their ignition system. It would serve as an add-on voltage amplification system that would not requiring any wiring skills to install rather unplug the spark plug boot from the spark plug and connecting the adapter to the spark plug and then connecting the sparkplug boot to the top of the adapter.

### BRIEF DESCRIPTION OF THE DRAWINGS

The invention will be described further, by way of example, with reference to the accompanying drawings, in which:

FIG. 1. is a cross section of the device with an electrical schematic showing the voltage amplifier with the hot and ground electrodes placed in a horizontal position in reference to the said invention.

FIG. 2. is a cross section of the said device with the hot and ground electrodes placed at an angle to each other.

FIG. 3. is a cross section of the spark plug adapter with the voltage amplifier built into it that fits on top of an existing spark plug and then connects to the spark plug boot.

FIG. 4. is a cross section of the spark plug with a stack of piezoelectric crystals and/or a device to alter the spark.

### DETAILED DESCRIPTION OF THE DRAWINGS

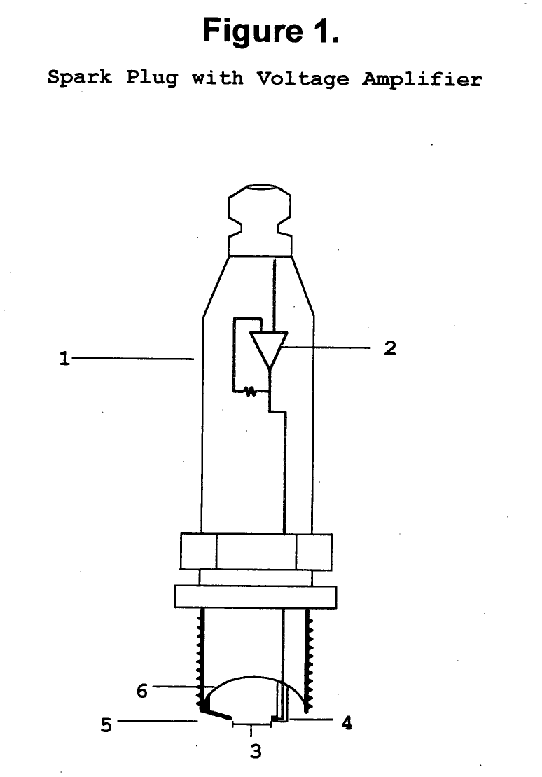

The embodiment shown in FIG. 1. comprises of a spark plug with a device that changes the spark characteristics as the electrical charge travels through and out the said device. The spark plug consists of an insulating jacket 1 made with an electric insulating material normally used in spark plug manufacturing by somebody skilled in the art. This insulating jacket starts at the top just below the connecting nut ( ) and encapsulating the voltage amplification device 2 and the heavy gauge/low resistance conductor leading down to the bottom electrode 4. Unlike conventional spark plugs though, the insulating jacket ends in a concave hemi-spherical cavity at the bottom of the spark plug. The purpose of this is to provide an outwardly projecting blast surface from which the initial explosion of the gas fuel mixture by the spark can be directed out into the combustion chamber. The spark would be centered over this concave blast surface formed by the insulting jacket. In addition, since the anode electrode would be located near the side of the bottom of the plug as shown FIG. 1., the insulating jacket 1 or other insulating material would shield the anode from other possible discharge surfaces other than the ground electrode 5. This ensures that the electron path from the anode 4 is always in the direction of the ground electrode rather that the walls of the cylinder or the outer threaded casing of the spark plug by eliminating the electron potential for other possible ground pathways. By situating the anode electrode and the ground electrode horizontal to each other in reference to the vertical axis of the spark plug; it enables the spark and resulting flame kernel to be unobstructed from the fuel/air mixture in the combustion chamber. Also importantly, by situating the anode and ground electrode on opposite sides of the bottom of the spark plug, it makes a longer spark path between the two electrodes. A longer spark path creates a greater contact area for the spark and the fuel air mixture hence the voltage amplifier to boost the voltage for the electrons to be able to overcome the electron potential needed to jump the longer gap. Higher voltage sparks produces increases in horsepower and lowers fuel consumption. Stand alone voltage amplification devices have done this commercially for years in auto ignition systems. This invention is specially designed to boost the voltage within the spark plug without the hassle of more complicated exterior add-ons. In addition, the spark plug is designed to be used for the higher voltage inputs by having the electrodes horizontal mounted at the bottom of the plug and spaced wider apart to accommodate the larger charge. In addition, heavier gauge wire could be used inside the plug to lessen the resistance of the higher current.

The top of the spark plug is not unlike traditional spark plugs serving as a connector and conductor to the spark plug wires. From there, a conductor with low resistance travels inside the insulting jacket to the voltage amplifier. The feedback loop of the voltage amplifier contains a resistor. After the voltage is amplified or increased within the voltage amplifier the current travels down the conductor which continues to be encapsulate by the insulating material until the conductor becomes exposed at the bottom of the spark plug as the anode electrode.

The metal body of the plug consists of the hex-nut exterior lower portion for the purposes of being able to fit and be turned by traditional deep sockets. The exterior metal body section continues down to the bottom of the plug. This metal section is threaded for securing the plug inside the engine block.

The anode or hot electrode 4 protrude out the bottom of the plug and are insulted on the their side closest to the cylinder wall. This is to ensure that a discharge from the electrode travels to the ground electrode instead of the wall of the cylinder or other conductive surfaces. The anode and cathode are spaced horizontally in relation to the plug. The spark gap 3 is wider to accommodate the larger spark. The width of the gap and the length and strength of the spark in combination with the horizontal placement of the electrodes are believed to provide an unrestricted flame kernel expansion from the ignition point into the cylinder. The electrically insulated concave shaped bottom of the plug helps direct and focus the explosion down the cylinder away from the plug 6. Alternatively, concave shaped bottom of the said invention 6 could be designed as the hot or ground electrode, having the spark being emitted directly from or to the concave bottom surface.

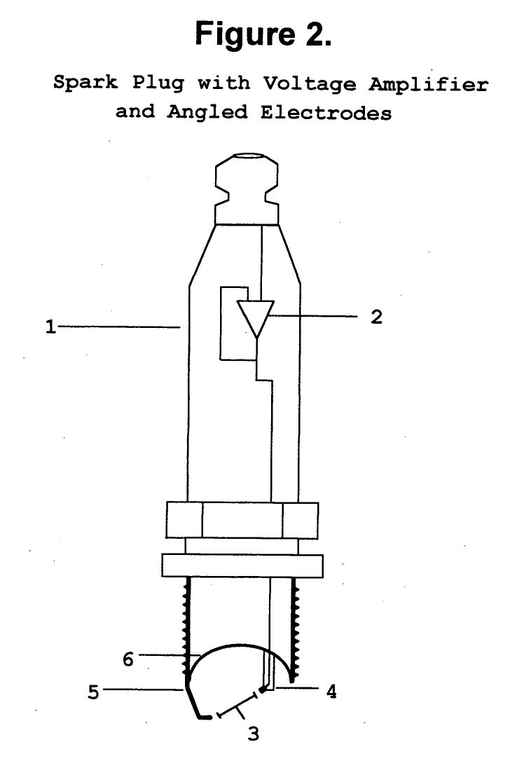

The embodiment shown in FIG. 2. is the said invention with the hot 4 and ground 5 electrodes placed at an angle to each other with a wide gap 3 to maximize the sparks exposure to the fuel mixture, utilizing the current output from the voltage amplifier of the said invention to achieve the wider gaping.

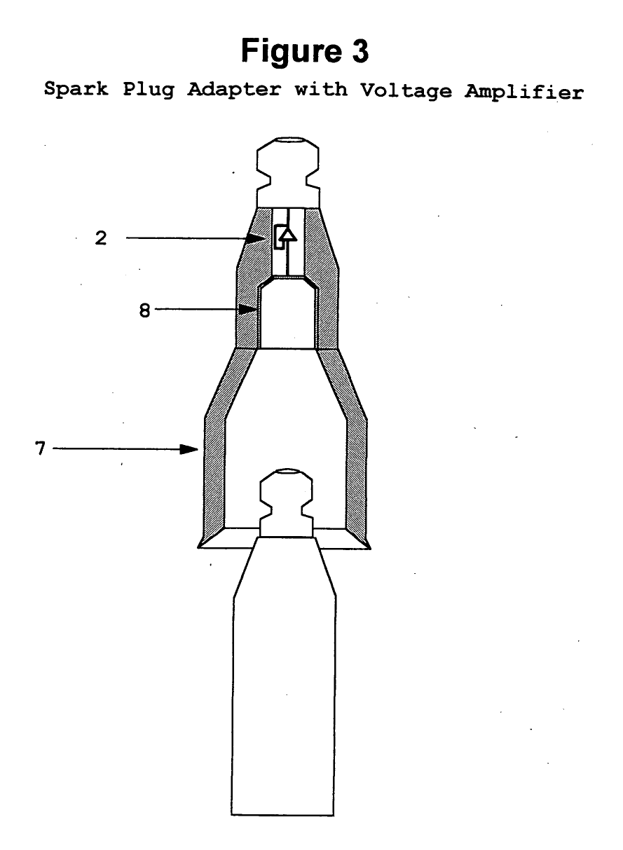

The embodiment shown in FIG. 3. comprises of a spark plug adapter having the same voltage amplification and spark modification devices 2 that accompany the first embodiment. The spark plug adapter has a spark plug boot 7, which fits over a spark plug providing a clean, secure fit and an electrical contact 8 from the adapter to the spark plug. The spark plug boot would be made of similar materials used by those skilled in the art. The head of the adapter is similar in design to a spark plug in order to fit inside the existing spark plug boots that are used in the engine.

The embodiment shown in FIG. 4 comprises of a spark plug with piezoelectric crystals 9 and/or a device to alter the characteristics of the spark in some form (e.g. increase voltage, change wave form, alter timing, alter duration etc . . . ). When a current is applied to piezoelectric crystals, the voltage is increased thereby generating a larger spark. Piezoelectric crystals are durable and can be used within spark plugs to generate higher voltages. In addition, a microprocessor, microchip, or similar device which could be implanted in the spark plug to change the dynamics of the spark.

Have described the preferred embodiment of the invention, what is claimed is:

1. A spark plug having:
a device that changes the characteristic of the spark emitted from the bottom of the spark plug,
said device comprising of a voltage amplifier or other device which increases the voltage output from the spark plug,
said device having a component that changes a wave form, duration, frequency or other characteristics of the spark including the number of sparks emitted.

2. A spark plug recited in claim 1 wherein,
said electrode and ground electrode are placed horizontally from each other at a greater distance to maximize spark contact with the fuel mixture, where the hot electrode and ground electrode are equal distance from the center of the plug,
said electrode and ground electrode are placed horizontally from each other at a greater distance to maximize spark contact with the fuel mixture, where the hot electrode and ground electrode are placed away from the center of the plug,
said electrode and ground electrode are placed vertically from each other on the bottom of said spark plug having a greater gapping distance, allowed by the greater voltage, to maximize spark contact with the fuel mixture,
said electrode and ground electrode are placed at an angle from each other on the bottom of said spark plug at a greater gapping distance, allowed by the greater voltage, so the gapping distance and angle are designed to maximize spark contact with the fuel mixture,

3. A spark plug recited in claim 1 wherein,
said two (2) or more hot electrodes exist to produce multiple sparks at multiple locations on the spark plug,

4. A spark plug recited in claim 2 including,
said concave surface above the electrodes and spark area to provide a ignition chamber which focuses the initial flame kernal produced from the combined spark and fuel
Said bottom concave surface of the said invention used as the hot or ground electrode.

5. A spark plug adapter for placing over the top of a spark plug containing
a voltage amplifier contained in said body for amplifying an electrical signal, said device having a component that changes a wave form, duration, frequency or other characteristics of the spark including the number of sparks emitted, a boot or clamp to go over and hold the said device firmly to the spark plug, and a top which fits securely inside spark plug wire boots for a engine similar in design to a top to a spark plug.
